(19) United States
(12) Patent Application Publication
(10) Pub. No.: US 2019/0066730 A1
(43) Pub. Date: Feb. 28, 2019

(54) SYSTEM AND METHOD FOR CREATING GROUP VIDEOS

(71) Applicant: Vid Inc., Los Angeles, CA (US)

(72) Inventors: Jagpal Singh, Worcester (GB); Maciej Dziedziela, Hertfordshire (GB)

(73) Assignee: Vid Inc., Los Angeles, CA (US)

(21) Appl. No.: 15/727,204

(22) Filed: Oct. 6, 2017

Related U.S. Application Data
(63) Continuation-in-part of application No. 15/686,842, filed on Aug. 25, 2017, now Pat. No. 10,178,365.

(51) Int. Cl. G11B 27/031; H04N 21/2743; H04N 21/218; G06F 17/30; G06Q 50/00

(52) U.S. Cl. CPC G11B 27/031; H04N 21/2743; G06Q 50/01; G06F 17/30817; G06F 17/30029; H04N 21/218

(57) ABSTRACT

A method for assisting a plurality of authors to generate a group video. The method comprises connecting a first electronic device of a first author with a server that provides communication among the plurality of authors; allowing the first author to create a project for generating a group video; allowing the first author to add a first video file to the project; transmitting metadata of the first video file to the server, wherein the metadata includes location and time information associated with the first video file; searching for potential participants of the project based on the location and time information of the first video file; obtaining follower information of the searched potential participants in a social platform and selecting a list of the potential participants based the follower information; providing the list to the first author for selecting a second author from the list to join the project; and transmitting an invitation message to the second author.

### RELATED APPLICATIONS

This application is a continuation in part of U.S. application Ser. No. 15/686,842, titled “System and Method for Combining Audio Tracks with Video Files,” filed on Aug. 25, 2017, the entirety of which is incorporated herein by reference.

### BACKGROUND

High definition cameras have become a common feature in all sorts of consumer electronic devices, ranging form computers to laptops, tablets, PDAs, and smart phones. Consumers can easily record videos in high quality and share them with friends across different social-media platforms, such as YouTube, Facebook, Snapchat and Instagram. Such a proliferation of video sharing could create boredom in content consumers because they have unwillingly watched similar videos about a same event that are published in various platforms by different users. Thus, when a same social event is being recorded by several people at the same time and then shared on social platforms, it has become more and more desirable to combine several videos of a same event to create a group video whose contents are richer and more comprehensive than any single video of those several videos.

### SUMMARY

An objective of the present application is to provide a video creation system and method such that a plurality of participants are prompted to join a group video creation project and make contributions to the group video in a plurality of ways. For example, each participant may provide his or her own videos to the project to make the contents of the group video much richer. In addition, each participant may allow the publication of the group video to his or her followers on a social platform, thus increasing the reach of the group video. The created group video may be published in the accounts of these participants on a social media platform such that followers of these participants can have a direct access to the same group video or may be published as a news or media feed pushed by the current system and method to an account or device of the followers. For example, the system and method as set forth in the present application may be implemented as a server-mobile App system, such as “Vid Platform,” and the users of the server-mobile App system form their own social platform and share the group videos among themselves. An advantage of the present system and method is that an author of a group video, regardless of whether he or she is a celebrity or not, could easily have thousands of audience by directly publishing the group video to all followers of the co-authors of the group video.

In another example, each participant may also assist the editing of the group video, like those that have been widely implemented in available video editing software, to improve the presentation of the group video. The present system and method is capable of processing these video editing requests in a more efficient manner.

To achieve the above-identified objectives, the present group video creation system and method are conceived to not only allow an author to manually invite a participant for the group video project, but also proactively search and identify potential participants for the group video creation project. The search and identification may be implemented before an event that is the subject of the group video, during the event, or after the event. For example, the present system and method may use the location and time information of a recording device used by two or more users to determine whether they are at a same event, such as a football game, and prompt them to make a group video project.

Another benefit of the video creation system and method of the present application is that they are capable of utilizing all available videos, including those that have been generated by strangers with the condition that those videos are recorded at a similar time and location, to generate a group video. To achieve such a benefit, the present system and method may search in its own database, such as a database of the “Vid Platform,” or the public space any video and store those videos a database that is made available for a group video creation project.

According to an aspect, the present application is directed to a method for assisting a plurality of authors to generate a group video. The method comprises connecting a first electronic device of a first author with a server that provides communication among the plurality of authors; allowing the first author to create a project for generating a group video; allowing the first author to add a first video file to the project; transmitting metadata of the first video file to the server, wherein the metadata includes location and time information associated with the first video file; searching for potential participants of the project based on the location and time information of the first video file; obtaining follower information of the searched potential participants in a social platform and selecting a list of the potential participants based the follower information; providing the list to the first author for selecting a second author from the list to join the project; and transmitting an invitation message to the second author.

According to an embodiment, the method further allows the second author to add a second video file to the project; and generating the group video based on the first video file and the second video file.

According to various embodiments, the method further ranks the potential participants based on the number of followers in the social platform, determines an overlap of the followers between a potential participant and the first author; and/or selects potential participants for the project based on the overlap or similar amount of followers, and searches for, during a social event, a plurality of users of the server to create a group video about the social event based on location and time information associated with electronic devices of the plurality of the users. The searching step comprises obtaining location and time information of a user when the user turns on a video recording function of a second electronic device; searching for other users that have similar location and time information; and prompting the searched users to create a group video.

According to yet other embodiments, the method transmits a reduced first video file to the server, wherein the reduced first video file represents the first video file with a reduced frame rate and resolution. The method also transmits a frame, such as the beginning frame, of the first video file in a grayscale to the server and then transmits the first video file to the server. The methods stores a plurality of public or transmitted first video files in a database of the server; and allows the first author and the second author to select a video file from the database for the project. The method further assigns the first author as a master author of the project; and allows the master author to set up a plurality of voting events and voting rules for the group video creation project. Information about voting events and rules are included in the invitation message.

According to yet another embodiment, the method provides a content feed related to the group video to all followers of the plurality of the authors in a social platform, such as “Vid Platform” that is formed by the users of a server set up according to the present application.

According to another aspect, the present application is directed to a recording medium storing an executable program that causes a processor to implement the method as set forth in the present application.

### BRIEF DESCRIPTION OF THE DRAWINGS

The above and other objects, features, and advantages of various embodiments as set forth in the present disclosure will be more apparent from the following detailed description of embodiments taken in conjunction with the accompanying drawings.

FIG. 1 illustrates a video editing system according to an embodiment of the present application.

FIG. 2 illustrates an exemplary structure of an electronic device according to an embodiment of the present application.

FIG. 3 illustrates a group video server according to an embodiment of the present application.

FIG. 4 illustrates a method of generating a group video according to an embodiment of the present application.

FIG. 5a illustrates a graphical user interface of a local application for selecting a video file according to an embodiment of the present application.

FIG. 5b illustrates a graphical user interface of a local application for editing a group video according to an embodiment of the present application.

FIG. 5c illustrates a graphical user interface of a local application for publishing a group video according to an embodiment of the present application.

### DETAILED DESCRIPTION

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like.

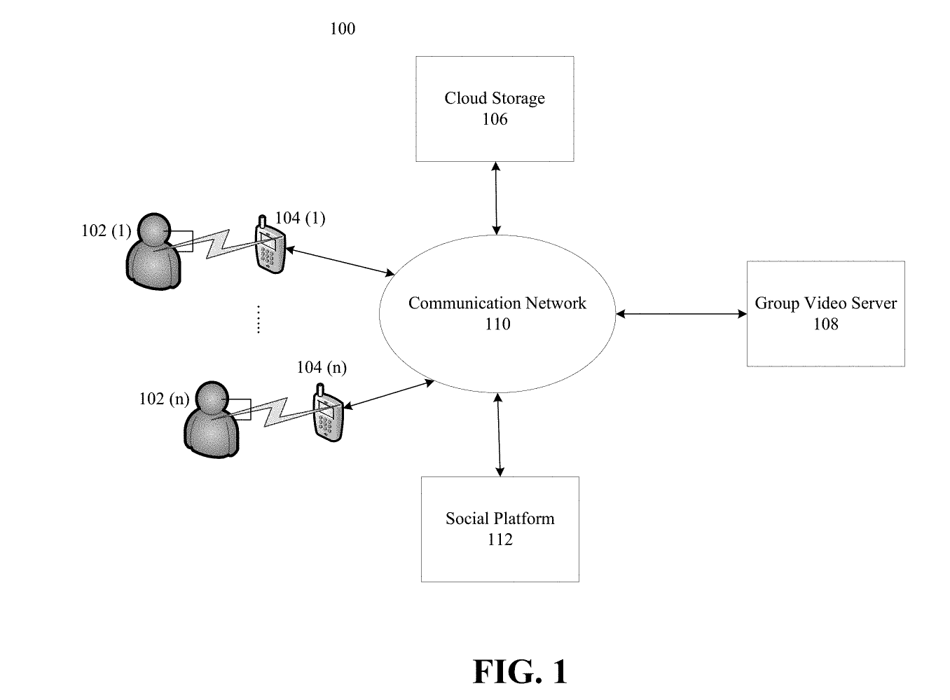

FIG. 1 illustrates a video editing system 100 according to an embodiment of the present application. The video editing system includes a plurality of users 102(1) to 102(n) who operate electronic devices 104(1) to 104(n) to communicate with, via a communication network 110, a cloud storage 106, a group video server 108, and a social platform 112. For the sake of brevity, the plurality of users 102(1) to 102(n) and the plurality of electronic devices 104(1) to 104(n) will be collectively referred to as the user 102 and the device 104 in this application, respectively, when the distinction among these users and devices is not needed. The plurality of users 102 may be a group of users who have attended a social event together, such as a sport event, a party, and a sightseeing. The plurality of users may be a group of users who have connected with each other via social platforms. In another embodiment, the plurality of users may be a group of user who have no connections with each other, but happen to be at a similar location and similar time with each other. The present video creation system and method allow the plurality of users 102 to create a group video by using all videos that have been provided by each of the plurality of users 102. In this way, the created group video can have a richer content than any of those individual videos.

The electronic device 104 is used by the user to record and store a plurality of video files. In an embodiment, the user 102 may also use the electronic device 104 for recording and then send the recorded video file to the cloud storage 106 for storage. The user 102 may also select one or more videos file, including the group video, to be published on the social platform 112. When the group video is published, a single feed about the group video is published in each account of the users 102. In this way, all followers of the users 102 on the social platform have a direct access to the group video and notice the publication of the group video. For example, a link to the group video may be provided on the home page of each of the users 102 such that every one who is allowed to visit those home pages can access the video via the link. The group video server 108 provides a series of processes and algorithms that assist the users 102 to create a group video, including setting up a group video project, discovering relevant participants of the group video project, logging changes to the group video made by each participant, providing real-time updates to each participant, and publishing the generated group video. Detailed functions and process of the group video server will be disclosed in the following parts of the present application.

As used in the present application, a server, a system, a cloud storage, or an electronic device may comprise a full-sized personal computer, a mobile device, a wearable device, or even a virtual device capable of exchanging data over a network. For example, a server, a system, or an electronic device may be an iPhone, an Android phone, a Blackberry phone, an iWatch, an iPad, or other internet-capable devices. The virtual device as used in the present application may refer to those virtual representations of a physical device, which is created by virtual reality technologies.

The communication network 110 should be broadly construed to include any one or more of a number of types of networks that may be created between devices using an internet connection, a LAN/WAN connection, a wireless connection, and so forth. For example, an electronic device may be operatively connected to network 110, via 3Q 4Q 5G or LTE networks. The terms “coupled with,” “operatively connected,” “operatively coupled,” and “communicatively coupled”, as used herein, mean that the elements so connected or coupled are adapted to transmit and/or receive data, or otherwise communicate. The communication network 110 may comprise various configurations and protocols including a cable network, the internet, World Wide Web, intranets, virtual private networks, wide area networks, local networks, private networks using communication protocols proprietary to one or more companies, Ethernet, WiFi and HTTP, cloud and cloud based services, and various combinations of the foregoing.

The social platform 112 may be understood as an online community for members to interact with each other. Some currently well-known social platforms include Facebook, Twitter, Google+, Four Squares, Instagram, Pinterest, and Tumblr. In an embodiment, the users of the group video server 108 may form their own social platform. For example, the system and method of the present application may be implemented in a server-mobile app system. The users of the server-mobile app system may form their own social platform called “Vid Platform.” In a social platform, a follower represents a user who chooses to see all of another user's posts in their content feed. The number of followers of a user indicates the influence of that user in a social platform. An important objective for a user to publish a content in a social platform is to raise his or her status in the social platform, attract more followers, and increase his or her influence in the social platform. According to an embodiment of the present application, when a user 102 publishes a group video, the followers of all the participants in creating the group video will receive a content feed from the group video server such that the followers have directly access to the published group video, thus increasing the impact and influence of the created group video. According to another embodiment, the group video server uses the followers in a social platform as a factor to search for potential participants for a group video.

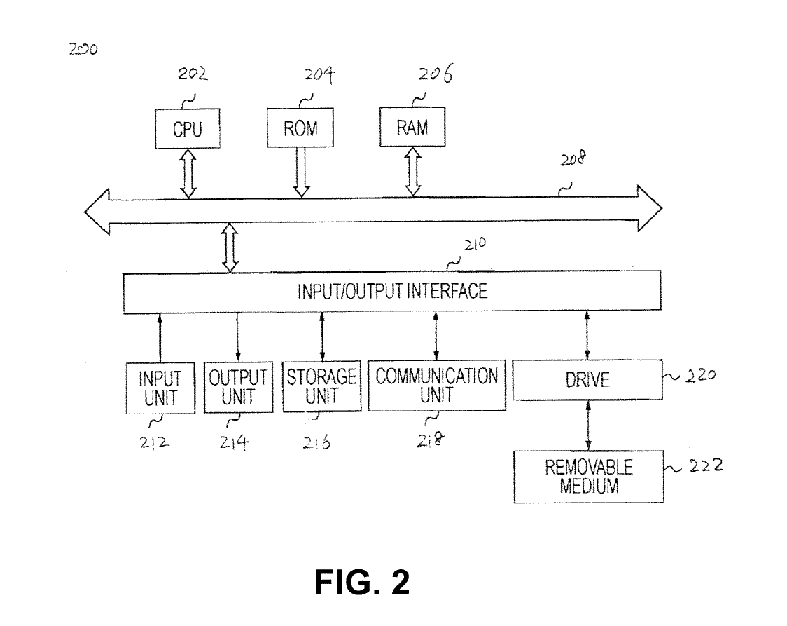

FIG. 2 illustrates an exemplary structure 200 of a server, a system, or an electronic device according to an embodiment. The exemplary structure 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interface 210 is also connected to the bus 208. In addition to the bus 208, the input unit 212, the output unit 214, the storage unit 216, the communication unit 218, and the drive 220 are connected to the input/output interface 210.

The CPU 202, such as a microprocessor, executes various kinds of processing in accordance with a program stored in the ROM 204 or in accordance with a program loaded into the RAM 206 from the storage unit 216 via the input/output interface 210 and the bus 208. The ROM 204 has stored therein a program to be executed by the CPU 202. The RAM 206 stores as appropriate a program to be executed by the CPU 202, and data necessary for the CPU 202 to execute various kinds of processing. The CPU 202 may include multiple processors such as ASICs, FPGAs, GPUs, etc. A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 212 includes a keyboard, a mouse, a microphone, a touch screen, and the like. When the input unit 212 is operated by a user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

The communication unit 218 includes a modem, a terminal adaptor, and other communication interfaces, and performs a communication process via the networks of FIG. 1.

A removable medium 222 formed of a magnetic disk, an optical disc, a magneto-optical disc, flash or EEPROM, SDSC (standard-capacity) card (SD card), or a semiconductor memory is loaded as appropriate into the drive 220. The drive 220 reads data recorded on the removable medium 222 or records predetermined data on the removable medium 222.

An operating system such as Microsoft Windows 10®, Microsoft Windows 7®, Windows XP® or Vista™, Linux®, Mac OS®, Unix®, iOS®, or Android®, may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET, Perl, Ruby, Python, SWIFT, OBJECTIVE C, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, JSON files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Video data may be encoded in a plurality of encoding formats, such as H.246 and MPEG and stored as AVI, MP4, MOV, or M4V files. Audio data may also be encoded in a plurality of encoding formats, such as AAC, AMR, and MPE, and stores as MPE or WAV files. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server.

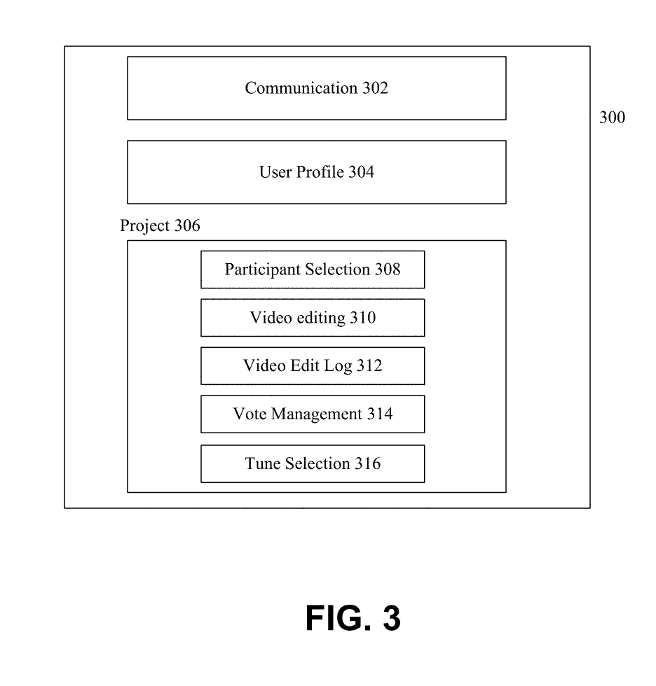

FIG. 3 illustrates a group video server 300 according to an embodiment of the present application. The group video server 300 includes a communication section 302, a user profile section 304, and a project section 306. The communication section 302 manages the communication between the group video server 300 and the plurality of electronic devices 104. The user profile section 304 manages user profiles of the plurality of users 102. The project section 306 manages the collaboration among the plurality of users 102 to create a group video.

One function of the communication section 302 is to maintain a connection with an electronic device whose user is participating in a group video project. In one embodiment, the communication section 302 pushes various messages to an electronic device of a user, which are related to a group video creation project. The communication section 302 may push messages to an electronic device before the participation of a group project, during the participation of a group video project, or after the participation of a group video project. For example, the communication section 302 may push a message to a plurality of electronic devices whose users are in the same stadium of a football game and prompt those users to collaborate with each other to create a group video. In another example, when the user has left a group video project, his or her device will receive messages from the group video server when additional changes are made to the group video. The message pushed by the group video server to the electronic device may be a push notification, a text message, an email, a feed in the user's account on a social platform, or a post in a local application of the electronic device.

In one embodiment, during the creation of a group video, the communication section 302 creates a direct and persistent WebSocket connection with electronic devices that are for creating the group video. A WebSocket connection may be understood as a computer communications protocol that is capable of providing two way communication channels over a single TCP connection. With the WebSocket connection, the communication section 302 is to provide real time updates to all users who are participating in a group video project. The communication section 302 monitors the changes made to the group video and record those changes in a log stored on the group video server. After a user makes changes to a group video, a message is transmitted to the group video server, and changes are recorded in the log accordingly. When the changes of the log are made, the communication section 302 informs all participants such that all participants know the updates to the group video in real time. In one embodiment, the message is transmitted from an electronic device to the server in the form of a JSON post.

The user profile section 304 is used to create and store the user's personal information, account information in a social platform, and privacy settings associated with the use of the group video server. The personal information may include the user's actual name, address, and contact information. The account information in a social platform may include names used by the user in various social platforms, and the list of followers associated with each account. The privacy settings may include the user's preferences and restrictions related to potential participants of a group video and potential viewers of a group video. For example, the privacy settings may include the following options:

Whether the user allows the group video server to search for potential participants in a group video creation project;

Whether the user would allow the group video server to recommend the user to other users for a group video creation project;

The degree of social vicinity with the user to be a participant in a group video creation project (The social vicinity refers to a measure of social relationship on a social platform);

The requirement on the number of followers for a stranger to be a participant in a group video creation project, and

Restrictions on sharing a group video.

The project section 306 is used to manage a group video creation project. The project section 306 includes a participant selection module 308, a video editing module 310, an edit log module 312, a voting module 314, and a tune selection module 316. The participant selection module 308 is configured to manage the participants of a group video, such as sending invites to participants selected by a user and searching for additional participants based on a plurality of algorithms. The video editing module 310 allows the participants to add video files from a plurality of video sources to a group video project, remove a video file, and edit added video files, such as length, display order, and resolution. The video editing log module 312 stores a plurality of log files recording changes made to the added video files. The voting module 314 allows all participants to cast a vote on the group video, including any intermediate changes to the group video and the final presentation of the group video. The tune selection module 316 allows the master author to select audio data for the created group video. Each of these modules of the group video project section 3016 will be discussed in more detail in the following parts of this application.

The participant selection module 308 manages who could participate in a group video creation project. In one embodiment, the participant selection module 308 receives an input from a user to start a group video creation project. The participant selection module 308, by default, designates the user who creates the group video project as the master author. The selection module 308 then waits for the master author to manually indicate participants of the group video project.

Optionally, the master author may request the participant selection module 308 to provide a list for potential participants, in which the selection module 308 searches for potential participants by using a plurality of algorithms. One algorithm searches for potential participants based on time and location. For example, the participant selection module 308 may search blogs or posts published by the master author in social platforms to discover recent social events that the master author has just participated. Based on the discovered recent social events, the participant selection module 308 may determine the time and location of those events and then use the time and location to search for potential participants in these social events and provides the list of the potential participants to the master author for selection. In another example, after the master author or a participant selects a video file for the group video, the time and location information of the video file are extracted and are used to search for more potential participants. The search of participants based on the time and location information may be further limited to the privacy settings of the master author. For example, the master author may restrict the potential participants within the circle of friends on a pre-determined list, connected members within a pre-determined social vicinity, or all the followers.

In one embodiment, the participant selection module 308 may further obtain information of followers of searched potential participants and use the information of followers to rank those potential participants. For example, the participant selection module 308 may rank those potential participants based on the number of their followers. The more followers a potential participant has the higher the ranking of that participant. The participant selection module 308 may also obtain a combined list of the followers of a potential participant and the master author. A longer list indicates a greater influence of the participant and the master author. In another example, the selection module 308 determines an overlap between the followers of the potential participant and the master author. A larger overlap indicates a common, but stronger influence.

In another embodiment, the participant selection module 308 has access to the location history of users and is configured to proactively prompt users of the group video server to collaborate with each other. For example, when a user of the present system is in a social event, the participant selection module 308 may retrieve the location and time information of the user and then search for other users of the present system who are at the same social event based on the time and location information. The retrieval of the location and time information may be triggered by an operation of the user on an electronic device. For example, when the user activates a local application of the present system on an electronic device, the local application obtains the location and time information and transmits them to the group video server. In another example, the retrieval of the location and time information is trigged when a user turns on the video recording function of an electronic device. When two users are found to be at a same social event, the participant selection module 308 instructs the communication section 302 to push messages to electronic devices of these two users and asking them whether they would like to create a group video together. A social event may be the gathering of a group people, such as a sport game, a musical show, or a party, or may be the focus on a common space, such as sightseeing of a same city, or may be any other interactions among a plurality of people.

In another embodiment, the participant selection module 308 allows the master author to assign his or her “master” status to another participant of the group video project. The master author may also remove one participant from the group video project.

A function of the video editing module 310 is to allow a participant to add video files to a group video from a plurality of video sources. In one embodiment, the video editing module allows a participant to add a video file from a local storage of an electronic device that is being used by the participant. In another embodiment, the video editing module 310 allows a participant to add a video file from an online storage source. In another embodiment, the group server 300 has a video vault that includes a plurality of short video segments, and the video editing module 310 allows a participant to select a video file from the video vault. In another embodiment, the video editing module 310 searches for publically available videos based on the location information and time information of the video file that has been added to the group video and then provides the searched videos to participants for selection.

Another function of the video editing module 310 is to provide a plurality of video editing options to participants, such as changing display order, trimming the video length, or adjusting the video resolution. In one embodiment, the group video server 300 merely provides these options to the participants, but does not provide the actual video editing functions associated with these options. Instead, the local electronic device has those video editing functions and implements the actual video editing tasks. In this way, the processing requirement and the network traffic imposed on the group video server are greatly reduced, thus allowing the group video server to handle many group video editing requests in real-time.

After a group video project is created, the video editing log module 312 generates a plurality of log files for the group video project. Each log file includes the identification of the plurality of video files in the group video, the user who provides that video file, changes that have been made to that video file, and the name of the participant who made those changes. The plurality of log files includes a current log file, a master log file, and a plurality of individual log files that are dedicated to each participant. The current log file includes the current editing options of the group video. The master log file includes all past changes that have been made to the group video. The individual log files include changes made by each participant to the group video. The video editing log module 312 monitors the changes made to the group video and stores each changes in the current log file, the master log file, and the corresponding individual log file. The current log file and the individual log file may be transmitted back to an associated participant such that that participant can easily see the current form of the group video and identify whether his or her suggestion to the group video has been accepted or not.

The voting module 314 is configured to accept votes from participants in deciding the presentation of the group video, including whether an editing option to the group video is accepted or not and whether the final presentation of the group video is accepted or not. For example, when participants make several changes to the display order of a video file, the master author can use the voting module 314 to set up a voting event for the display order of that particular video file. In addition, when the master author deems that the group video is completed, he or she may set up a voting event to decide whether the group video is acceptable by all the participants or not. The master author is allowed to set up the voting rules when the group video project is initiated. The voting rules will be provided to a potential participant in the invite because the voting rules may be a factor in deciding whether to join the group video creation project. In one embodiment, once a second participant (in addition to the master author) joins the group video creation project, the voting rules cannot be changed.

After the group video has been accepted by all participants, the group server 300 allows the master author to select audio data for the group video by using the tune selection module 316. In one embodiment, the group server 300 and the tune selection module include those functions and algorithms as described in U.S. application Ser. No. 15/686,842, titled “System and Method for Combining Audio Tracks with Video Files,” filed on Aug. 25, 2017, the entirety of which is incorporated herein by reference.

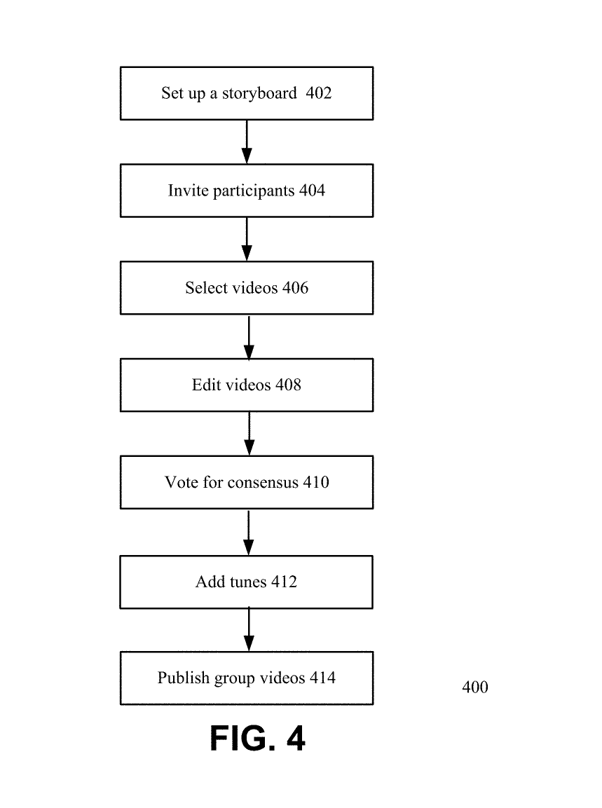

FIG. 4 illustrates a method for generating a group video according to an embodiment of the present application. At step 402, a user of the group server 300 sets up a group video creation project using a local application installed on the electronic device 104. The group video creation project may be referred to as a storyboard in the present application. The user gives a name to the storyboard and uploads a video file to the storyboard. In an embodiment, the group video server 300 extracts location information from a video file of the storyboard and names the storyboard by a landmark or address associated with the location information. The local application transmits, to the group video server, information about the storyboard, including identification of the user, the name of the storyboard, metadata of the added video, and time and date associated with the event that is the subject of the group video. In one embodiment, the local application further transmits a reduced version of the video file added by the user. The reduced version may be thumbnail images extracted from the video file or may be the same video file but with reduced resolution or frame rate. The thumbnail image may be a grayscale image of the beginning frame of the video file. In an alternative embodiment, the local application transmits a copy of the entire video file to the group server 300 after the reduced version of thumbnail image has been transmitted.

Upon, receiving the above-identified information, the group server 300 establishes a direct and persistent communication with the user's electronic device, such as by maintaining a WebSocket connection with the electronic device of the user. In addition, the group server 300 creates the plurality of log files that store changes made to the group video by the participants. The group video server 300 also extracts the location and time data from the metadata and searches for other users who have similar location and time history. The group server 300 may first search the user's contact list or fiend lists in a social platform. In addition, the group video server 300 may search history of all users of the group server. The group video server 300 then transmits the list of users who have similar location and time history with the added video file to the electronic device of the user. In addition, the group video server 300 will assign a master author status to the user and allow the user to set up any voting events and associated voting rules.

At step 404, the electronic device used by the user presents the list of potential participants to the user for selection. In another embodiment, the user may enter the information of participants manually. Once the selection is made by the user, the electronic device sends a message to the group server 300, which, in turn, sends a request to the selected potential participants to invite them to join the group video story project. The request will identify the master author of the storyboard, information about the past social event, and any other information about the group video creation project, such as voting events and voting rules.

At step 406, the potential participants accept the invitation and join the storyboard. Each participant is allowed to upload at least one video file to the storyboard. The video file may be stored at a local storage of the electronic device or may be stored at a cloud storage managed by a participant. In an embodiment, the group video server 300 has a database that stores a plurality of publically available video files with a short length, such as several seconds. Each time a video file is added to the storyboard, a message is transmitted from a local electronic device to the group video server 300, which will store those changes to the log files and push those changes to the storyboard of each electronic device.

At step 408, the plurality of video files added to the storyboard are edited by all participants. Each participant is allowed to change the display order of the video files, trim the length of the video files, or adjust resolution of each video file. In one embodiment, the group video server 300 may arrange the video files in a predetermined display order. For example, the group video server 300 may first arrange the video files according to their time information. In another example, the group video server 300 may first separate the added video files according to their location information by placing video files adjacent to one location into a same group and them arrange the video file according to the time they were recorded in each group. When the participants make a change to the video files, a message, such as a JSON post, is transmitted to the group video server 300 such that the group video server can record those changes in the log files and update each local storyboard with those changes. In case one or more users are not connected while a change is made, the user may receive a push notification on his or her electronic device or online account, letting them know that changes have been made to the storyboard.

At step 410, the master author may start voting for certain events from time to time. For example, when two video files having similar contents are added to the storyboard, the master author may ask all participants to vote for one video file that will be included in the group video. In one embodiment, the group video server 300 allows the master author to assign the status of a master author to another participant. To facilitate the video editing process, the local application may also have a message or chat system embedded in the storyboard such that participants can discuss the video editing suggestions and effects. Once a participant has applied all changes, that participant is allowed to set his or her status as inactive. In another embodiment, the master author can set a voting event so that every participant decides whether they are satisfied with the group video at its current form.

At step 412, the mater author is allowed to add audio data, such as a tune, to the group video, as described the previous parts of the present application. At step 414, the group video server 300 publishes the group video by posting a video feed or link in the account for each of the participants. In another embodiment, the group video server may also publish the video feed or link to all followers of the participants. To reduce repetitive content feeds to a follower, the publishing step 414 combines the lists of all followers of the participants and removes the redundant names such that each follower will receive a content feed related to the group video just once.

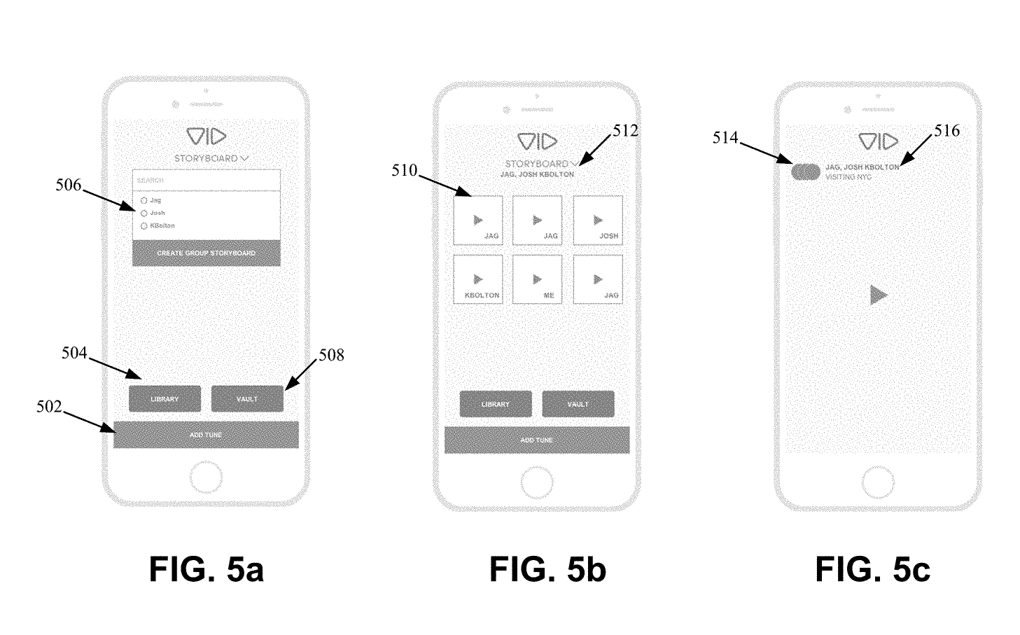

FIGS. 5a-c illustrate graphical user interfaces of a mobile application installed on an electronic device according to an embodiment of the present application. The electronic device may be an Android phone or an iOS phone. The mobile application, known as an “App,” is installed on the electronic device to assist a user to create a group video. FIG. 5a illustrates a graphical user interface for a user to add video files to a storyboard, which represents a group video creation project. The user interface provides a function 502 for adding a tune to a video or a group video, a function 504 for selecting a video file from a local storage, a function 508 for selecting a video file from a database operated by the group video server 300, and a function 506 for selecting a potential participant. The list of potential participants associated with the function 506 may be input manually by the user, or may be obtained from the user's friend list, or may be discovered by the group video server 300 based on the metadata of an added video file and the social vicinity determined by the user.

FIG. 5b illustrates a graphical user interface for editing the added video files 510. The user interface also shows the names of all participants 512, which are allowed to change the display order of the video files, trim the video files, and adjust their resolutions.

FIG. 5c illustrates a user interface with a published group video. A video feed or link 514 is posted to the accounts of all participants 516 such that the followers of those participants 516 can access the group video directly via the video feed or link.

The benefits and advantages of the present application may be further understood with the assistance of the following example. Three friends A, B, and C have gone on a weekend away together to Los Angeles. They all use social media frequently and enjoy publishing videos on interesting social events. For such a trip, each of these three friends would usually post one or more videos about the trip to Instagram, snapchat and etc. Their wider friend circle likely will see the same posts individually on each of their profiles, which are similar and repetitive. It would be preferable if they could post all together and have all their friends view their combined content. To create a group video, one of the friends uses the system and method as set forth in the present application to set up a group video project and invites the other friend to join the group video creation projection. In response, each friend accepts the invitation and adds the film video clips of their own respective to the group creation project. The three friends can then together edit the group video and publish that group video to all of their followers. This enables the viewers to get multiple perspectives on the trip and a richer view. It also prevents the viewers from being bored by repetitive contents. Finally, it enables the three friends to tell a more cohesive immersive story that will reach a wider audience of their combined followers rather than just their personal followers.

It is generally known that the video clips recorded an electronic device, such as iPhone, will also have the geographical metadata. In one embodiment, the present system and method will extract the metadata from a video file that has been added to the group video in order to assist the participants to identify more users who should be collaborating in the group video creation project. The present system and method uses the geographical coordinates, time and date when the videos where shot and the users, and the degree of social vicinity to the user (such as direct friends or friends of friends) to find more potential participants. Another factor in identifying more participants may be based on user's previous interaction with other users, such as comments among the users, regardless of the social vicinity.

In another embodiment, the present system and method will request a consent from a user to share his/her location even when a local application associated with the present system and method is not running. This will allow the local application to send a signal to the group video server at specific intervals with the time and location information of a user. This will allow the present system to identify and send notifications to users that are or were in the proximity of each other in the same or close time span. The notification will invite users to join to a group video creation project. The produced video will be richer and will be displayed in the feed of all contributors. This will generate a higher view rate as well as number of comments. The matching algorithm will match users with similar number of friends, in the same geographical area, with a very similar time span giving priority to the social vicinity

While this invention has been described in conjunction with the specific embodiments outlined above, it is evident that many alternatives, modifications, and variations will be apparent to those ordinarily skilled in the art. Accordingly, the preferred embodiments of the invention as set forth above are intended to be illustrative, not limiting. Various changes may be made without departing from the spirit and scope of the inventions as defined in the following claims.

1. A method for assisting a plurality of authors to generate a group video, comprising:
connecting a first electronic device of a first author with a server that provides communication among the plurality of authors;
allowing the first author to create a project for generating a group video;
allowing the first author to add a first video file to the project;
transmitting metadata of the first video file to the server, wherein the metadata includes location and time information associated with the first video file;
searching for potential participants of the project based on the location and time information of the first video file;
obtaining follower information of the searched potential participants in a social platform;
determining an overlap of the obtained follower information between the first author and the searched potential participants; and selecting a list of the potential participants based on the overlap;
providing the list to the first author for selecting a second author from the list to join the project;
transmitting an invitation message to the second author;
allowing the first author to set up a plurality of voting events and voting rules for the project, wherein the voting rules are used to decide the content and changes made to the group video.

2. The method according to claim 1, further comprising:
allowing the second author to add a second video file to the project; and
generating the group video based on the first video file and the second video file.

3. The method according to claim 1, further comprising:
ranking the potential participants based on the number of followers in the social platform.

4. The method according to claim 1, further comprising:
determining a number of followers of the first author and the searched potential participants; and
selecting a potential participant for the project when the first author and that potential participant have a similar amount of followers.

5. The method according to claim 1, further comprising:
searching for, during a social event, a plurality of users of the server to create a group video about the social event based on location and time information associated with electronic devices of the plurality of the users.

6. The method according to claim 5, wherein the step of searching for the plurality of users comprises:
obtaining location and time information of a user when the user turns on a video recording function of a second electronic device;
searching for other users that have similar location and time information; and
prompting the searched users to create a group video.

7. The method according to claim 1, further comprising:
transmitting a thumbnail image of the first video file to the server, and then transmitting the first video file to the server.

8. The method according to claim 1, further comprising:
storing a plurality of public video files in a database of the server; and
allowing the first author and the second author to select a video file from the plurality of the public video files for the project.

9. The method according to claim 1, further comprising:
assigning the first author as a master author of the project,
wherein the group video includes the first video file and a plurality of other video files created by other authors, and
wherein the voting event establishes an order of the first video file and the plurality of other video files within the group video.

10. The method according to claim 9, wherein information about voting events and rules are included in the invitation message.

11. The method according to claim 1, further comprising:
providing a content feed related to the group video to all followers of the plurality of the authors in a social platform.

12. A non-transitory recording medium storing an executable program which, when executed, causes a processor to implement a method for assisting a plurality of authors to generate a group video, the method comprising:
connecting a first electronic device of a first author with a server that provides communication among the plurality of authors;
allowing the first author to create a project for generating a group video;
allowing the first author to add a first video file to the project;
transmitting metadata of the first video file to the server, wherein the metadata includes location and time information associated with the first video file;
searching for potential participants of the project based on the location and time information of the first video file;
determining an overlap of the obtained follower information between the first author and the searched potential participants; and selecting a list of the potential participants based on the overlap;
providing the list to the first author for selecting a second author from the list to join the project;
transmitting an invitation message to the second author; and
allowing the first author to set up a plurality of voting events and voting rules for the project, wherein the voting rules are used to decide the content and changes made to the group video.

13. The recording medium according to claim 12, wherein the method further comprises:
allowing the second author to add a second video file to the project; and
generating the group video based on the first video file and the second video file.

14. The recording medium according to claim 12, wherein the method further comprises:
ranking the potential participants based on the number of followers in the social platform.

15. The recording medium according to claim 12, wherein the method further comprises:
determining a number of followers of the first author and the searched potential participants; and
selecting a potential participant for the project when the first author and that potential participant have a similar amount of followers.

16. The recording medium according to claim 12, wherein the method further comprises:
searching for, during a social event, a plurality of users of the server to create a group video about the social event based on location and time information associated with electronic devices of the plurality of the users.

17. The recording medium according to claim 16, wherein the step of searching for the plurality of users comprises:
obtaining location and time information of a user when the user turns on a video recording function of a second electronic device;
searching for other users that have similar location and time information; and
prompting the searched users to create a group video.

18. The recording medium according to claim 12, wherein the method further comprises:
transmitting a thumbnail image of the first video file to the server, and then transmitting the first video file to the server.

19. The recording medium according to claim 12, wherein the method further comprises:
storing a plurality of public video files in a database of the server; and
allowing the first author and the second author to select a video file from the plurality of the public video files for the project.

20. The recording medium according to claim 12, wherein the method further comprises:
assigning the first author as a master author of the project,
wherein the group video includes the first video file and a plurality of other video files created by other authors, and
wherein the voting event establishes an order of the first video file and the plurality of other video files within the group video.

21. The recording medium according to claim 20, wherein information about voting events and rules are included in the invitation message.

22. The recording medium according to claim 12, wherein the method further comprises:
providing a content feed related to the group video to all followers of the plurality of the authors in a social platform.
